(19) United States
(12) Patent Application Publication
(10) Pub. No.: US 2003/0191706 A1
(43) Pub. Date: Oct. 9, 2003

(54) Green coffee exchange

(76) Inventor: Richard Robert Dubois, North Smithfield, RI (US)

Correspondence Address: RICHARD ROBERT DUBOIS, 76 WARREN AVENUE, NORTH SMITHFIELD, RI, 02895, US

(21) Appl. No.: 10/113,883

(22) Filed: Apr. 1, 2002

(51) Int. Cl. G06F 17/60

(52) U.S. Cl. 705/37

(57) ABSTRACT

The Green Coffee Exchange is an Internet auction trading platform for “industrial level” trading of green coffee beans for the coffee industry. The Green Coffee Exchange opens up the limited, narrow green coffee trading marketplace that exists today into a global marketplace for professional buyers and sellers of green coffee beans. This invention provides the capabilities for “coffee farmers” (growers) and the “coffee buyers” to trade directly with each other. The Green Coffee Exchange eliminates the additional layers of middlemen and their exorbinate mark-ups in both the coffee growing countries and the coffee consuming (importing) countries. Ex. USA. Also, this invention creates logistical efficiencies by streamlining the international green coffee supply-chain; which generates storage and transportation synergies that will allow “coffee farmers” and the “coffee buyers” to substantially increase their profitability.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND

The Field of Endeavor to which this invention pertains to is “international green coffee bean trading” for the industrial green coffee market over the Internet.

This invention allows for an international green coffee trading auction to be transacted over the Internet.

My invention allows green coffee trading without green coffee buyers or sellers “physically” traveling one air or sea mile. This invention allows the “coffee farmers” (growers) the capability to market their green coffee bean harvests to the world's industrial green coffee bean purchasing community. Without the Green Coffee Exchange the “coffee farmers” are severely restricted to a limited narrow group of coffee buyers from coffee consuming countries that have the capital resources to send green coffee buyers to the coffee producing regions of the world and that possess the intellectual resources needed to transact international trade. Also, the coffee farmers' marketability is greatly hampered by the small group of exporters in their own countries.

These current avenues of marketability offer extremely low prices to the “coffee farmers” for their coffee harvests. The prices the “coffee farmer” receives for their green coffee beans is so low that it cannot sustain a decent standard of living for the coffee farmers and their families. The “coffee farmers” lack of access to the broader green coffee purchasing community can be overcome by utilizing the Green Coffee Exchange Internet auction.

### STATE OF THE ART

Coffee farmers in the coffee producing regions of the world; Mexico, Latin, Central and South America, Africa and Asia coffee farmers are paid a subsistence wage or less for their coffee harvests. This low income forces the (growers) “coffee farmers” indigenous to these regions to exist without the basic necessities of life (a Third World existence). Many coffee farmers and their families do not even have enough income to feed their families and themselves each day. Survival is an every day challenge. No plumbing, clean water to drink or bathe daily are the norm for many of the farmers and health care is practically non-existent.

Coffee farmers and their extended families often succumb to disease and combat an unusually high infant mortality rate. This traditional coffee trade practice of purchasing green coffee at extremely low prices is known as “sweatshop coffee”.

This invention allows the coffee farmers an opportunity to obtain a better price for their coffee harvest. The current economic conditions in these coffee producing regions leads to a continuous “cycle of poverty” for these hardworking coffee growers and their families and to political instability throughout the region. By utilizing the Green Coffee Exchange these coffee farmers can obtain a greater price for their coffee on the global marketplace which is created by the Green Coffee Exchange; as compared to the narrow green coffee marketing system that exists today. The pricing, transportation and storage synergies created by using the Green Coffee Exchange's direct trading system capabilities will allow the growers a fighting chance to finally break their “cycle of poverty” and allow the “roasters” the opportunity to streamline their green coffee procurement operations. The positive financial benefits created by the Green Coffee Exchange will be felt by all participants throughout the international green coffee supply chain.

### BRIEF SUMMARY OF THE INVENTION

The Green Coffee Exchange is an international green coffee bean trading Internet auction for “industrial level” green coffee trading. “Coffee farmers” (sellers of green coffee) in coffee producing countries will be able to list their inventories of green coffee beans for sale, “auction”, on the Green Coffee Exchange. “Coffee roasters” (buyers of green coffee) in coffee consuming countries will be able to purchase, “bid” on, lot(s) (one lot=33,000 lbs of green coffee beans) of green coffee beans without physically traveling to the coffee producing countries. The Green Coffee Exchange is a business-to-business Internet application.

The Green Coffee Exchange Internet auction will benefit the growers, “coffee farmers”, and the “roasters” of coffee by creating a marketplace that will allow direct trading with each other and eliminate the costly middlemen and warehousing fees associated with the old “traditional” lines of the “coffee trade” and distribution.

The coffee farmers will retain a greater profit for their green coffee beans because of the competitive “bidding” environment that the Green Coffee Exchange creates. Also, the roasters of green coffee will benefit economically because the price they will pay the “coffee farmers' using the Green Coffee Exchange will be substantially lower than the price they pay for green coffee beans from the “traditional old line” (ex. importers and brokers) green coffee supply-chain in today's industrial green coffee marketplace.

### OBJECTS

The object of the invention is to open the narrow “old line coffee trade supply chain” that inhibits “coffee farmers” (growers) in coffee producing countries and “coffee roasters” in coffee consuming countries to an extremely limited “green coffee marketplace” that exists today; into an entirely new global marketplace for international green coffee trading.

It is the object of this invention to trade green coffee beans internatinally over the Internet without “physically” traveling to the coffee growing countries.

It is the object of this invention to help the “coffee farmers” (growers) obtain a better price for their coffee harvests by allowing “direct trade” between the coffee farmers and the “industrial green coffee buyers”.

Another object of this invention is to benefit the “coffee roasters” by eliminating the storage fees and the exorbinant fees (mark-ups) of the middlemen that currently dominate the international green coffee supply-chain worldwide.

Yet another object of this invention is to allow “coffee buyers” the opportunity to “view” photographs of the “lot(s)” of green coffee beans without the major hurdle of traveling great distances to the coffee growing regions of the world.

Yet another object of this invention is to transform even a small company or any size company that uses the Green Coffee Exchange Internet auction into an international trading house.

Still yet another object of this invention is to welcome and allow all “coffee growers” including “Fair Trade Certified Coffee Growers” the opportunity to participate in this “global” green coffee bean trading exchange.

Still yet another object of this invention is to streamline or tighten the international green coffee bean trade's supply-chain through the efficiencies created by “direct trade” between the “coffee growers” and the “coffee roasters”.

### BRIEF DESCRIPTION OF THE SEVERAL VIEWS OF THE DRAWINGS

Not Applicable

### DETAILED DESCRIPTION OF THE INVENTION

The Green Coffee Exchange is an Internet auction for the industrial green coffee market that allows all participants the opportunity to “buy and sell” lot(s) of green coffee beans over the Internet. Through the direct trading capabilities of the Green Coffee Exchange, coffee farmers will be able to sell their coffee harvests to a worldwide marketplace of professional green coffee buyers.

The Green Coffee Exchange is technologically seemless and architectually transportable for usage within any computer platform. The invention is scalable to any computer platform. The use of this application on the Internet provides global access for all users in a multi-user environment. The Green Coffee Exchange is a Business-to-Business Internet Application.

Example of old “traditional” lines of coffee trading: Brokers and middlemen in coffee producing countries who buy and sell green coffee beans for customers, importers, and roasters located in the United States of America and throughout the world; many time selling exclusively to one specific client (but not always), lock in a price that the grower, “coffee farmer”, “accepts” because of the lack of marketability to contact other potential buyers. The brokers' client (the roaster or importer) in the USA or in any coffee consuming and roasting country is limited to the coffee offered by their broker and middlemen of the old “traditional” coffee trade system. This narrow, old line coffee trade inhibits the “growers” and “roasters” to an extremely limited coffee marketplace.

The Green Coffee Exchange opens the “growers” and the “roasters” coffee trading marketplace to the entire world! The elimination of these additional layers of middlemen in both the coffee “producing” (originating) countries and in the “roasters” (consuming) countries (also in the form of storage fees), will allow the “growers” (coffee farmers) an opportunity to offer their coffee to a broad, worldwide marketplace and substantially increase the “coffee farmers” ability to obtain a better price for their coffee.

The “roaster” also benefits by dealing directly with the coffee grower by sharing in the savings generated by the elimination of the additional storage fees and warehousing costs, as well as from the costly circuitous transportation routes of the old line coffee trade and the exorbitant mark-ups of the middlemen that dominate the “traditional coffee trade”. The overall logistical and financial costs of this old line coffee trade will be dramatically reduced.

The elimination of these additional layers of middlemen in both the coffee “producing” (originating) countries and in the “roasters” (consuming) countries will have a substantial positive financial impact for the growers and the roasters of green coffee.

Logistically, the Green Coffee Exchange is an “international supply-chain mangement tool”. Transportation synergies will be created because of supply-chain streamlining; through more direct trade routes, less storage time, financial and administrative efficiencies. Compared to the traditional old-line coffee trading and distribution systems that involves additional warehousing, many trans-shipment arrangements and break bulk points that requires physically handling the green coffee many more times than a direct trade movement.

As well as the elimination of the excessive mark-ups of the middlemen.

The positive efficiencies created by the Green Coffee Exchange Internet auction will develop substantially greater profitability for all participants in this new approach to international green coffee trading. The Green Coffee Exchange levels the “playing field” for all participants.

Through the Green Coffee Exchange's direct international trading capabilities, the coffee farmer will have the opportunity to offer (sell) their coffee harvests to a broad worldwide marketplace and substantially increase the “coffee farmers” ability to obtain a better price for their coffee beans. Also, the Green Coffee Exchange enables the “coffee roaster” to purchase green coffee directly from the (growers) coffee farmers without sending a “green coffee buyer” traveling great distances to the coffee producing (growing) countries to purchase green coffee beans.

“Coffee roasters” who roast green coffee beans, then grind, pack and distribute coffee in coffee consuming countries (ex. USA) who have never participated in direct international coffee trading by traveling to the coffee (originating) producing countries “physically” themselves will now be able to access these coffee harvests in the coffee originating countries by using the Green Coffee Exchange. By using the Green Coffee Exchange any roaster or green coffee buyer located anywhere in the world can gain direct access to the coffee producing “source”, “coffee farmers”.

The giant coffee roasters of the coffee industry could use the Green Coffee Exchange to purchase their green coffee beans more efficiently and from a greater number of “coffee sources”. Also, as a managerial cost cutting tool, (ex. buyers traveling expenses). Further, large coffee roasters could improve their overall international supply-chain through the logistical synergies that the Green Coffee Exchange generates.

Both sides of the bilateral international green coffee trading equation (buyers and sellers) will benefit from the direct trading capabilities of the Green Coffee Exchange's Internet auction system.

Coffee farmers and coffee roasters will enjoy a substantial increase in profitability from the greater efficiencies created by the synergies of a direct exchange of trading with “principles” and not through intermediaries! “Roasters” trading directly with “growers” is smart business. The Green Coffee Exchange gives your firm the direct trading advantage.

The Green Coffee Exchange transforms your company into an international trading house which helps you widen your profit margins and provide a better life for coffee farmers and their families. The Green Coffee Exchange welcomes all coffee growers including Fair Trade Certified Coffee Growers.

GREEN COFFEE EXCHANGE HOME PAGE

Members listed on the Green Coffee Exchange

| 1 | (LINK) to search all members | | |
|---|---|---|---|
| | Growers “Coffee Farmers” | | |
| | Including fair trade certified coffee growers | | |
| | Roasters “Commercial” | | |
| | Registration easy and free | | |
| 2 | (LINK) to register | | |
| 3 | Coffee Growers Representing | | |
| | Central America | South America | North America |
| | Nicaragua | Brazil | Mexico |
| | Panama | Colombia | Hawaii |
| | Honduras | | |
| | Guatemala | | |
| | Asia | Africa | West Indies |
| | Indonesia | Kenya | Jamaica |
| | Vietnam | Ethiopia | |

| | |
|---|---|
| 4 | (LINK) |

Coffee News Section
Weather Reports

GREEN COFFEE EXCHANGE INVENTORY LISTING PAGE

BUYERS
Search Inventory

| | |
|---|---|
| 5 | (LINK) Shows all green coffee auctions listed on exchange |
| 6 | (LINK) Buyer types in specific request |
| a | Quantity |
| b | Grade |
| c | Screen |
| d | Arabica |
| e | Robusta |
| f | Caffeinated |
| g | Decaffeinated |
| h | Country of Origin |
| i | Additional Space For Comments |

SELLERS
Green Coffee Offerings

| | |
|---|---|
| 7 | (LINK) Seller types in inventory |
| a | Quantity |
| b | Grade |
| c | Screen |
| d | Arabica |
| e | Robusta |
| f | Caffeinated |
| g | Decaffeinated |
| h | Country of Origin |
| i | Lot Number |
| j | Additional Space For Comments |
| j | Additional Space For Comments |

GREEN COFFEE EXCHANGE AUCTION DISPLAY PAGE

| | |
|---|---|
| 8 | Description of Lot |
| 9 | Lot Number |
| 10 | Quantity |
| 11 | Grade |
| 12 | Screen |
| 13 | Arabica |
| 14 | Robusta |
| 15 | Caffeinated |
| 16 | Decaffeinated |
| 17 | Country of Origin |
| 18 | (total) kg pounds |
| 19 | (total) Burlap Bags 60 kg 132 lbs. each |
| 20 | Picture of Green Coffee Beans |
| 21 | Picture of Coffee Estate (optional) |
| 22 | Seller/Grower Post Shipping Terms |
| 23 | Sailing and Arrival Dates if Available |
| 24 | Lot Number Offered At (Price) Per Pound U.S. Dollars |
| 25 | Bid Increments (At Any Price Bidders Want) |
| 26 | Auction Opens (As Soon As Lot Is Posted) |
| 27 | Auction Closes |
| 28 | Lot Number Total Bids Entered So Far |

GREEN COFFEE EXCHANGE BIDDING PAGE

ENTER HERE TO BID

| | | |
|---|---|---|
| 29 | (LINK) | Type in Identification of Registered Buyer |
| 30 | | Auction Currency Is In U.S. Dollars |
| 31 | (LINK) | Type In Your Bid $ |
| 32 | | Buyer is notified by the Green Coffee Exchange |
| | | that the Buyer's bid has been received. |
| 33 | (LINK) | Registered users can view winning “Bid” at close |
| | | of auction. |
| 34 | | Glossary of International Shipping terms for |
| | | general information purpose. |

GREEN COFFEE EXCHANGE HOME PAGE EXPLANATION

| | | |
|---|---|---|
| 1 | (LINK) | Allows a user to search a complete list of all |
| | | Registered Members on the Green Coffee Exchange; |
| | | “coffee farmers” (growers) including Fair Trade |
| | | Certified Coffee Growers and a list of all |
| | | “industrial level green coffee buyers”. |
| 2 | (LINK) | Allows a user to “Register” (Free) as a “buyer” or |
| | | as a “seller” of green coffee beans on the Green |
| | | Coffee Exchange. |
| 3 | | A list of coffee growing countries is displayed |
| | | and categorized by region of the world. Ex.: |
| | | South America, Asia. |
| 4 | (LINK) | Allows a user to access a “Coffee News Section” |
| | | and “Weather Reports” for various coffee growing |
| | | regions. |

GREEN COFFEE EXCHANGE INVENTORY LISTING
PAGE EXPLANATION

| 5 | (LINK) | Allows “Registered Users” to search entire |
|---|---|---|
| | | inventory of all green coffee auctions listed on |
| | | the Green Coffee Exchange. |
| 6 | (LINK) | Allows “Registered Buyers” of green coffee beans |
| | | to type in specific requests in this location. |
| a | | Quantity |
| b | | Grade |
| c | | Screen |
| d | | Arabica |
| e | | Robusta |
| f | | Caffeinated |
| g | | Decaffeinated |
| h | | Country where green coffee originates |
| i | | Allows “Registered Buyers” a space to type in |
| | | comments |
| 7 | (LINK) | Allows “Registered Sellers” of green coffee beans |
| | | to type in their green coffee bean inventories |
| | | (offerings) lot(s) in this location. |

| | |
|---|---|
| a | Quantity |
| b | Grade |
| c | Screen |
| d | Arabica |
| e | Robusta |
| f | Caffeinated |
| g | Decaffeinated |
| h | Country where green coffee beans originates |
| i | Allow “Registered Sellers” a space to type in |
| | comments |

GREEN COFFEE EXCHANGE AUCTION DISPLAY
PAGE EXPLANATION

| | |
|---|---|
| 8 | Displays the description of a particular “lot(s)” of green |
| | coffee beans offered for auction on the Green Coffee |
| | Exchange. |
| 9 | Displays the “lot(s)” number assigned to a particular |
| | “lot(s)” of green coffee offered for auction on the Green |
| | Coffee Exchange. |
| 10 | Displays the “Quantity” of a particular “lot(s)” of green |
| | coffee beans offered for auction on the Green Coffee |
| | Exchange. |
| 11 | Displays the “Grade” of a particular “lot(s)” of green |
| | coffee beans offered for auction on the Green Coffee |
| | Exchange. |
| 12 | Displays the “Screen” of a particular “lot(s)” of green |
| | coffee beans offered for auction on the Green Coffee |
| | Exchange. |
| 13 | Displays whether a “lot(s)” of green coffee beans is |
| | “Arabica” coffee. |
| 14 | Displays whether a “lot(s)” of green coffee beans is |
| | “Robusta” coffee. |
| 15 | Displays whether a “lot(s)” of green coffee beans is |
| | “Caffeinated” coffee. |
| 16 | Displays whether a “lot(s)” of green coffee beans is |
| | “Decaffeinated” coffee. |
| 17 | Displays the country where the green coffee beans |
| | originated. |
| 18 | Displays the total net weight of “lot(s)” of green coffee |
| | beans in kg and pounds. |
| 19 | Displays the total number of bags at 60 kg and 132 lbs. in |
| | this particular auction. |
| 20 | Displays a photo of the “lot(s)” of green coffee beans |
| | offered in this particular auction. (This feature is |
| | optional.) |
| 21 | Displays a photo of the “coffee farm” where the “lot(s)” of |
| | green coffee offered in this particular auction were grown. |
| | (This feature is optional.) |
| 22 | Displays the “Shipping Terms” posted by the “Seller” on the |
| | “lot(s)” of green coffee beans offered in this particular |
| | auction. (This feature is optional.) |
| 23 | Displays “Sailing and Arrival Dates” posted by the “Seller” |
| | in this particular auction. (This feature is optional.) |
| 24 | Displays the “lot(s)” number and current “Offered Price” per |
| | pound in U.S. Dollars in this particular auction. |
| 25 | Displays a statement issued by the Green Coffee Exchange |
| | stating that “Bid Increments” are at the discretion of the |
| | “Bidder”. (Ex.: 1 cent to $1,000.00 bid increments) |
| 26 | Displays a statement issued by the Green Coffee Exchange |
| | stating that a particular “Auction” begins as the lot(s) of |
| | a particular green coffee auction have been successfully |
| | posted on the Green Coffee Exchange's Inventory Page by the |
| | “Seller”. |
| 27 | Displays a statement issued by the Green Coffee Exchange |
| | stating the exact time (EST) that a “green coffee auction” |
| | for a particular “lot(s)” of green coffee beans closes. |
| | (Many “green coffee auctions” are posted and available for |
| | “Bidding” simultaneously on the Green Coffee Exchange.”) |
| 28 | Displays the “lot(s)” number and the “Total” number of |
| | “Bids” entered so far on a particular “green coffee |
| | auction”. |

GREEN COFFEE EXCHANGE BIDDING PAGE EXPLANATION

| | | |
|---|---|---|
| 29 | (LINK) | Allows a “Registered Buyer” to type in their |
| | | “identification code” in this space which allows |
| | | the “Registered Buyer” to enter a “Bid” for that |
| | | particular “lot(s)” of green coffee beans in that |
| | | particular green coffee auction offered on the |
| | | Green Coffee Exchange. |
| 30 | | Displays a statement issued by the Green Coffee |
| | | Exchange stating that the “Auction Currency” is |
| | | posted in U.S. Dollars. |
| 31 | (LINK) | Allows a “Registered Buyer” to type in their “Bid” |
| | | for a particular “lot(s)” of green coffee beans |
| | | offered for auction on the Green Coffee Exchange. |
| 32 | | Displayed in this space a “Registered Buyer” is |
| | | notified by the Green Coffee Exchange that the |
| | | “Registered Buyer's Bid” has been successfully |
| | | received by the Green Coffee Exchange. |
| 33 | (LINK) | Allows Registered Users, Buyers and Sellers to |
| | | view the winning “Bid” at the close of a |
| | | particular auction that was listed on the Green |
| | | Coffee Exchange. |
| 34 | | Displayed in this space is a “Glossary of |
| | | International Shipping Terms” for general |
| | | information purposes. |

1 A method for an international internet industrial level auction for the trading of green coffee beans, the method comprising a plurality of coffee growers and coffee buyers.

2 The method of claim 1, wherein provides means for said growers, including fair trade certified growers to sell said coffee.

3 The method of claim 1, wherein provides means to trade said coffee.

4 A method for a global business-to-business internet auction exchange platform for trading green coffee beans, the method comprising direct trade between a plurality of coffee growers and green coffee buyers.

5 The method of claim 4, wherein provides means for an international marketplace for coffee professionals to trade said coffee.

6 The method of claim 4, wherein provides means for growers to display said coffee to a worldwide marketplace.

7 The method of claim 4, wherein provides means for bidding on said coffee by said buyers worldwide.

8 The method of claim 4, wherein provides means for a business-to-business internet application for buying and selling said coffee.

9 A method for an international trading supply chain management tool for the green coffee industry, the method comprising a substantially more efficient international green coffee supply chain.

10 The method of claim 9, wherein provides means for substantial financial and logistical synergies for coffee professionals.
